(19) United States
(12) Patent Application Publication
(10) Pub. No.: US 2012/0298808 A1
(43) Pub. Date: Nov. 29, 2012

(54) Method and Apparatus For Adjusting The Height of a Failed Furniture Cylinder

(76) Inventor: Timothy Lee Lockwood, Rescue, CA (US)

(21) Appl. No.: 13/115,110

(22) Filed: May 25, 2011

(51) Int. Cl. F16L 3/12; F16L 3/00

(52) U.S. Cl. 248/49

(57) ABSTRACT

A system for adjusting and maintaining the height of a failed adjustable cylinder used in furniture is provided. The clamps 10 “C-shaped” in cross section and are sized with an interior region 18 thereof similar to a diameter of a cylindrical surface 64 of the cylinder 60. The clamps 10 are sufficiently resilient that the clamps 10 can be flexed to allow the cylinder 60 to pass into and reside within the interior region 18. The clamps 10 thus adjust and maintain the desired height of the furniture utilizing an adjustable cylinder.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

The following invention relates to removable clamp spacers for maintaining the height of furniture, specifically those that use an adjustable cylinder for height adjustment.

2. Prior Art

A variety of different situations exists where a need is presented for adjusting and maintaining the proper height of furniture, such as a chair or work surface, that utilizes an adjustable cylinder. For instance, the adjustable cylinder may fail to support the weight of the occupant, may not consistently maintain the correct ergonomic height, or may fail over time as gas or fluid leaks from the cylinder.

Conventional 2 piece clamps that are joined with a fastener to provide a clamping force are not convenient to install and require the use of tools. U.S. patent application Ser. No. 10/400,495 to Hamilton (2003) shows a 2 piece clamp placed around a cylinder and secured with screws. Additionally, such clamps have a tendency to score the metal of the adjustable cylinder they are attached to. If the cylinder is lubricated, as in the case of most adjustable cylinders used for a chair, the conventional clamp will slide and not hold in place.

Concave channels are also “C-shaped” in cross section and are used to hold cylindrical element in place. U.S. Pat. No. 4,903,629 to Mauldin (1990) is utilized to maintain a boat cover in place. U.S. Pat. No. 7,144,209 to Komine (2006) is used to cover up a slot or home formed in a machine tool. While similar in shape, neither are used in a manner to maintain the height of a failed adjustable cylinder.

Another class of connectors utilize an elongate clamp having a “C-shaped” cross-section and is formed of a resilient material allowing the clamp to open and close somewhat. An interior region of the clamp is sized to conform to a size of cylindrical frame element. For instance, U.S. Pat. No. 4,759,518 to Yardas (1988) show a trash bag support system requires specialized frame elements. U.S. Pat. No. 5,752,297 to Ramey (1998), U.S. Pat. No. 1,362,651 to Towns (1919) and U.S. Pat. No. 6,148,488 to Gristock (2000) show a method and apparatus for securing flexible sheeting to a cylindrical structure requires sheeting used in conjunction with cylindrical pipe structures. U.S. Pat. No. 3,816,885 to Saether (1974) utilizes flexible cables as frame elements. U.S. Pat. No. 7,162,836 to Van Straaten (2007) show a clamp being used to connect 2 cylindrical frame elements. U.S. Pat. No. D474,968 to Hicks (2003) show a elongate c-shaped closure device for paper or plastic bags that encloses a cylindrical element. None of the disclosed prior art are used for maintaining the height of an adjustable cylinder.

While many different methods exist for replacing a failed adjustable cylinder, there are no methods that allow for a tool free installation and removal of an apparatus to adjust and maintain the proper height without removing the failed adjustable cylinder. Accordingly, a need exists for a system which is useable to readily adjust a furniture cylinder to maintain a desired height, with the clamp system being readily undone to allow for reconfiguration or when no longer needed.

### BACKGROUND OF INVENTION

### Objects and Advantages

Accordingly, besides the objects and advantages of the apparatus for adjusting and maintaining the height of furniture utilizing adjustable cylinders, several objects and advantages of the present invention are:
(a) to provide a method of using multiple clamps to maintain consistent height for furniture utilizing adjustable cylinders.
(b) to provide a system for temporary use in maintaining the height for furniture utilizing adjustable cylinders.
(c) to provide a clamping system to maintain the height for furniture utilizing adjustable cylinders in a manner which is easily attachable and detachable.
(d) to provide a clamping system that can be used on commonly available adjustable cylinders.
(e) to provide a clamp which exhibits sufficient flexibility to allow the adjustable cylinder to pass into the cylindrical interior of the clamp and sufficient rigidity to require more force to remove the clamp from the adjustable cylinder than would typically be applied thereto by ordinary forces applied to the clamp and adjustable cylinder, such as a person sitting or leaning on the furniture.
(f) To be formed from readily available materials and has a configuration which facilitates manufacture of the clamp utilizing a variety of different methods including injection molding or extrusion from a plastic material.

Further objects of this invention will become apparent from a careful reading of the claims and detailed description provided herein as well as from review of the drawings.

### SUMMARY

This invention provides a method and apparatus to adjust and maintain a consistent height for furniture utilizing adjustable cylinders for height adjustment.

Each clamp is an elongate construct having a generally “C-shaped” contour. Each clamp includes an interior region which is generally circular and has a diameter similar to a diameter of a cylindrical surface of the adjustable cylinder to which the clamp attaches. A gap leads from outside of the interior into the interior of the clamp. The gap has lips defining its width which can be resiliently displaced away from each other when a force is applied against the lips by the elongate adjustable cylinder element. The lips can pivot sufficiently to allow the adjustable cylinder element to pass through the gap and into the interior of the clamp. The lips then return to their original position securing the adjustable cylinder element within the interior. This process can be reversed to remove the adjustable cylinder element out of the interior and away from the clamp.

Multiple clamps of various heights may be used to reach the desired support level. Ribs can be provided on an inner surface of the interior of the clamp which extends toward a center of the interior of the clamp. The ribs assist is reducing the surface friction of the clamp on the adjustable cylinder and help with placement of the clamp.

### DRAWINGS

### Figures

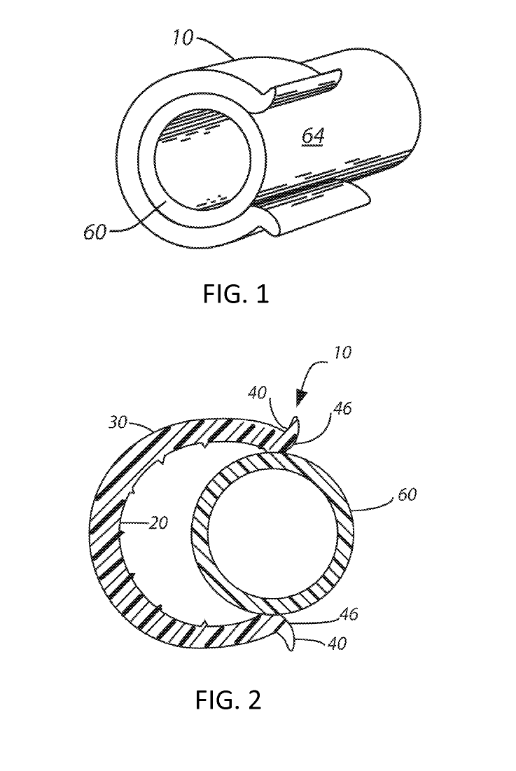

FIG. 1 is a perspective view of the connection system including a clamp secured to an adjustable cylinder element.

FIG. 2 is a full sectional view of the clamp.

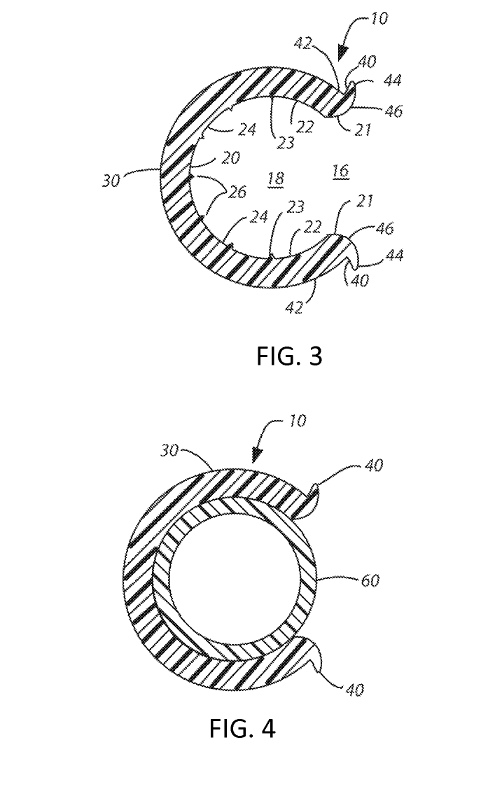

FIG. 3 is a sectional view of the clamp and the adjustable cylinder element of this invention, exhibiting the process of placing the clamp over the adjustable cylinder to form the connection in FIG. 1.

FIG. 4 is a full sectional view of that which is shown in FIG. 1

### DETAILED DESCRIPTION

### FIGS. 1, 2, 3 and 4

### Preferred Embodiment

With Reference to the drawings, wherein like reference numerals represent like parts throughout the various drawing figures, reference numeral 10 is directed to a clamp for maintaining the height of the adjustable cylinder element 60.

In essence, and with particular reference to FIGS. 1-4, the clamp system of this application includes the following basic details. The clamp 10 is generally “C-shaped” in cross section having a gap 16 leading into an interior 18. The interior 18 is generally cylindrical and has a diameter which matches a diameter of the cylindrical surface 64 of the adjustable cylinder element 60. The clamp 10 is defined around the interior 18 by the inner surface 20 and also includes an outer surface 30 parallel to and spaced from the inner surface 20. The clamp has 2 lips 40 defining the edges of the gap 16. The lips 40 extend away from the gap 16 to tips 44 allowing the clamp 10 to more easily pass around the cylindrical adjustable cylinder element 60.

More specifically, and with particular references to FIGS. 2 and 3, details of the clamp 10 are provided. The clamp 10 is an elongate substantially rigid construct having a constant substantially “C-shaped” cross-section along its entire length. The clamp 10 includes a first end 12 spaced from a second end 14. The clamp 10 exhibits a gap 16 on one side thereof which leads into an interior region 18 of the clamp 10.

The interior region 18 is defined by the inner surface 20 which is substantially cylindrical except that it is broken at the location of the gap 16. The inner surface 20 thus has a throat portion 21 adjacent gap 16, a diverging region 22 where two opposite walls of the inner surface 20 diverge away from each other, an extreme 23 where a maximum width of the inner surface 20 is provided and a converging region 24 where opposite walls of the inner surface 20 return toward each other until they meet at a side of the inner surface 20 opposite gap 16.

Because the inner surface 20 exhibits a first narrow width, then increasing width along the diverging region 22, and then decreasing width from extreme 23 to the converging region 24, the adjustable cylinder element 60 can be trapped within the interior 18 with the clamp 10 and secured to the adjustable cylinder element 60.

The clamp 10 is preferably formed from a material which exhibits an optimum amount of both elasticity and rigidity. Specifically, the clamp 10 is sufficiently flexible and elastic that the throat 21 of the inner surface 20 can be flexed open to a width which matches a width of the extreme 23 of the inner surface 20 without undergoing plastic deformation or other permanent damage to the clamp 10. The clamp 10 must be sufficiently resilient and elastic that the throat 21 will return to its original position once the adjustable cylinder element 60 is located entirely within the interior 18 or has been removed away from the clamp.

Additionally, the clamp 10 must exhibit sufficient rigidity that the throat 21 cannot be too easily opened and closed, but rather so that the clamp 10 will securely hold the adjustable cylinder element 60 within the interior 18 of the clamp 10 unless a non-incidental force is applied to remove the adjustable cylinder element 60 out of the interior 18 of the clamp 10. Different applications for the connection system of this invention could require different forces for securing the clamps 10 to the adjustable cylinder element 60 and for removal of the adjustable cylinder element 60 from the clamp 10. Through selection of different materials and through appropriate selection of thicknesses for the clamp 10 between the inner surface 20 and the outer surface 30, the force necessary to cause the throat 21 to match in width the width of extreme 23 can be selected to be any of a variety of different forces, depending on the particular application.

The inner surface 20 of the clamp 10 is preferably provided with a series of ribs 26 which extend away from the inner surface 20 and toward a center of the interior 18 of the clamp 10. The ribs 26 preferably have a height of only one-hundredth when clamp 10 is securely fastened to adjustable cylinder 60.

Note that the inner surface 20 actually has a diameter which is slightly less than the adjustable cylinder element 60, so that the clamp 10 remains expanded somewhat at all times then the adjustable cylinder element 60 is located therein.

Expansion of the clamp 10 is further enhanced slightly by the height of the ribs 26. Thus a slight friction fit is provided between clamp 10 and adjustable cylinder element 60 to prevent the clamp from sliding along the long axis thereof out of its desired position.

For adjustable cylinder element 60 having different diameters and for applications where a greater or lesser amount of force is desired for attachment or detachment of the clamps 10 to the adjustable cylinder element 60, the dimensions would be altered accordingly to provide the desired design characteristics.

The ribs 26 are preferably substantially triangular in configuration so that they have a point that provides enough friction to maintain position, but not prevent clamp 10 from being moved into position. Preferably, the ribs 26 are only located between the extremes 23 and along the converging region 24 of the inner surface 20. Thus, the ribs 26 do not interfere with the attachment and detachment of clamp 10 to the adjustable cylinder element 60. Rather, the diverging region 22 and throat 21 of the inner surface 20 are preferably smooth.

The throat 21 off the inner surface 20 provides the two opposing surfaces which define the gap 16 of the clamp 10. The clamp 10 does not stop at the throat 21, but rather continues beyond the gap 16 with the lips 40. Preferably, one lip 40 is provided at each side of the gap 16 so that each side of the throat 21 has a lip 40 attached thereto. Each lip 40 has a base 42 where the lip 40 attaches to the cylindrical portion of the clamp 10 and a tip 44 opposite the base 42. Preferably, the lip 40 curves from the base 42 to the tip 44 in a direction which causes the two lips 40 to curve away from each other and away from gap 16.

Preferably, the curvature of the lips 40 is sufficient that the tips 44 are spaced further away from each other than a width of the adjustable cylinder element 60. In this way, then the clamp 10 is to be secured over the adjustable cylinder element 60, the adjustable cylinder element 60 first abuts a contact surface 46 between the tip 44 and the base 42 of each lip 40, rather than directly abutting the tips 44 of lips 40. The lips 40 and the attached diverging regions 22 of the clamp 10 are thus encouraged to be spread apart from each other, rather than merely being pushed in toward other portions of the clamp. The contact surface 46 is preferably smooth so that a continuous smooth surface is provided for contact of the adjustable cylindrical element 60 with inner surface 20 of the clamp 10 entirely in position within the interior 18 of the clamp 10 (FIG. 4).

Preferably, the clamp 10 is formed in a continuous linear shape formed from a hydrocarbon polymer material using the extrusion process. The hydrocarbon polymer would enable a tight fit conforming to large arcs or bends of adjustable cylinders.

### Advantages

From the description above a number of advantages of my adjustable cylinder furniture clamp become evident:
(a) No tools are required for installing or removing the clamps that maintain furniture height.
(b) A consistent furniture height can be maintained regardless of cylinder condition.
(c) It is cheaper to maintain the height of adjustable cylinder furniture with clamps than replacing the original cylinder.
(d) Unskilled labor can perform installation and removal.
(e) The operational limit of the adjustable cylinder can be exceeded using the clamps for heavy individuals.
(f) The curved lip of the clamp will provide a superior surface to grasp for installation and removal.
(g) The clamps may be used together to create a proper ergonomic height for the user.
(h) The clamps may be removed and reused at the useful end of life of the furniture so as to further reduce costs.

### Conclusion, Ramification, and Scope

Accordingly the reader will see that the one or more adjustable clamp of this invention can be used to adjust and maintain the height of furniture utilizing an adjustable cylinder easily and conveniently, and can be removed easily and conveniently when no longer needed. Ergonomic height of furniture may be maintained regardless of the condition of the adjustable cylinder. Furthermore, the clamp has additional advantages in that:
it allows for a tool free installation and removal;
it allows for a consistent furniture height can be maintained even if the adjustable cylinder malfunctions;
it is more cost effective and quicker to use that typical replacement of a failed adjustable cylinder;
it allows unskilled and end user labor to perform installation and removal;
it provides additional lift capacity when heavy individuals exceed the operational limit of the adjustable cylinder can be exceeded using the clamps;
it provides a curved lip of the clamp will provide a superior surface to grasp for installation and removal;
it allows one or more clamps may be used together to create a proper ergonomic height for the user;
it allows the clamps may be removed and reused at the useful end of life.

Having thus described the invention, it should be readily apparent that various different modifications could be resorted to without diverging from the scope and fair meaning of this invention.

Although the description above contains many specificities, these should not be construed as limiting the scope of the invention but as merely providing illustrations of some of the presently preferred embodiments of this invention. For example, various different dimensions of the clamps and adjustable cylinder and configurations could be provided without diverging from this disclosure. Additionally, the specific locations for ribs 26 could be altered depending on the need to reduce friction.

I claim:

1. A system for maintaining the height of an adjustable cylinder for furniture in a fixed position, comprising in combination:

2. The system of claim 1 wherein each said clamp includes two lips, one lip located along each edge of said clamp facing said gap, each said lip including a base adjacent said clamp and a tip opposite said base, said tips of said two lips spaced further from each other than a width of said gap; and
a. Wherein said lips are closer to each other at a location between said base and said tip of each said lip than said lips are away from each other at said tip of each said lip.

3. The system of claim 1 wherein each said clamp exhibits a plurality of ribs extending away from said inner surface of said clamp and toward said interior region.

4. The system of claim 3 wherein each said rib is oriented along a line parallel to a central axis of said clamp, said ribs restricted to portions of said inner surface between an extreme of said inner surface where said inner surface exhibits a maximum width and a side of said inner surface opposite said gap.

5. The system of claim 1 wherein said gap exhibits a width less than a diameter of said inner surface of said clamp and wherein said gap exhibits a width greater than one-half of said diameter of said inner surface.

6. The system of claim 1 wherein the adjustable cylinder element is curved and said clamps are formed from a material having sufficient flexibility to allow said clamp to bend to exhibit a radius of curvature exhibited by said adjustable cylinder element.

7. The system of claim 1 wherein said clamps are formed from a common hydrocarbon polymer material.

8. The system of claim 1 wherein said clamps are formed of polyvinyl chloride.

9. A system for maintaining an adjustable cylinder in a fixed position, comprising in combination:
a. An elongate adjustable cylinder having a substantially cylindrical surface;
b. One or more clamps wherein each said clamp having a substantially cylindrical inner surface, said inner surface of said clamps having a diameter substantially identical to the diameter of said cylindrical surface of adjustable cylinder element;
c. Each said clamp having a gap passing into an interior region of said clamp faced by said inner surface;
d. Each said clamp formed of resilient material allowing said gap of each said clamp to flex open to an amount equal to one of the said diameters of the adjustable cylinder element; and
e. Wherein said clamps are formed from a material having sufficient flexibility to allow said clamp to bend to exhibit a radius of curvature matching the radius of curvature exhibited by said curved adjustable cylinder.

10. A clamp for maintaining an adjustable cylinder in a fixed position, said clamp comprising in combination:
a. An inner surface having a cylindrical contour and defining an interior region of said clamp;
b. Said inner surface extending from a first lip to a second lip, said first lip and said second lip spaced apart by a gap, said gap providing access into said interior region; and
c. Said inner surface having a pair of extremes defining uppermost and lowermost locations on said inner surface, said extremes spaced apart by a diameter of said inner surface, said inner surface being continuously curving on one side of said extremes and said inner surface broken by said gap on a side of said extremes opposite said one side.

11. The clamp of claim 10 wherein said clamp includes ribs extending from said inner surface of said clamp, said ribs entirely positioned on said one side of said extremes opposite said gap.

12. The clamp of claim 10 wherein said clamp is formed from a material exhibiting sufficient flexibility to allow said first lip and said second lip to be displaced away from each other up to an amount equal to said diameter of said inner surface, without permanent deformation of said clamp; and
a. Wherein said first lip and said second lip each include a tip defining an extremity of said first lip and said second lip, said tip of said first lip being spaced away from said tip of said second lip by a distance greater than a width of said gap.
